(19) United States
(12) Patent Application Publication
(10) Pub. No.: US 2010/0214889 A1
(43) Pub. Date: Aug. 26, 2010

(54) MEDIA PROCESSING DEVICE, MEDIA PROCESSING SYSTEM, AND MEDIA PROCESSING METHOD

(75) Inventor: Hidetoshi Maeshima, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/710,902

(22) Filed: Feb. 23, 2010

(30) Foreign Application Priority Data
Feb. 25, 2009 (JP) 2009-042926

(51) Int. Cl. G11B 19/02; G06F 15/02

(52) U.S. Cl. 369/47.14; 369/53.2; 358/1.18; G9B/19.001

(57) ABSTRACT

A media processing device can identify particular attributes of the recording media, such as the type of recording medium, and can sort by attribute a plurality of intermingled recording media including recording media that may or may not have been previously used and recording media of uncertain type. The media processing device has a plurality of media storage units that are capable of storing a plurality of recording media; a data reading unit that executes a reading process to read data written to a plurality of the recording media; a transportation unit that can convey the recording media to the plural media storage units and the data reading unit; a media identification unit that can identify individual attributes of the plural recording media based on a result of the reading process executed by the data reading unit; and a transportation control unit that causes the transportation unit to convey the recording media to different media storage units according to said attributes based on the identification results of the media identification unit.

### BACKGROUND OF THE INVENTION

1. Field of Invention

The present invention relates to a media processing device, a media processing system, and a media processing method that read and write data on disc-shaped recording media such as CDs and DVDs, and also print on the label side of such recording media.

2. Description of Related Art

Media processing devices that have a media storage unit for storing recording media such as CDs and DVDs, a media drive for writing data to recording media and reading data from recording media, a label printer for printing a label containing such information as the title of the written data or the date the disc was recorded on the label side of the recording media to which the data was written, a media transportation mechanism for conveying the recording media, and a control unit for controlling driving other parts of the media processing device are known from the literature. See, for example, Japanese Unexamined Patent Appl. Pub. JP-A-2006-331534.

A user that uses the media processing device taught in JP-A-2006-331534 can thus both write data and print a label by supplying blank media, that is, recording media that have not been used and to which the data writing process has not been applied, to the media processing device. The user can also print a label on previously recorded media by supplying the media processing device with recording media to which data has already been written.

However, when a plurality of such recording media including both previously recorded media and media that may or may not be unused (referred to below as “possibly blank recording media”) are used for writing data or printing a label by means of this media processing device according to the related art, the user must first separate the possibly blank media from the rest of the plural media. In addition, when the plural recording media to be used in the media processing device include recording media of unknown type (such as CD-R and DVD-RW) or write-once media that cannot be re-recorded, the user must also separate the usable recording media from the unusable media.

### SUMMARY OF THE INVENTION

A media processing device, a media processing system, and a media processing method according to the present invention can identify the type or other attribute of the recording media and can sort the recording media by attribute when supplied with a mixture of recording media including possibly blank recording media and recording media of unknown type.

A first aspect of the invention is a media processing device that solves the foregoing problem and has a plurality of media storage units that are capable of storing a plurality of recording media; a data reading unit that executes a reading process to read data written to a plurality of the recording media; a transportation unit that can convey the recording media to the plural media storage units and the data reading unit; a media identification unit that can identify individual attributes of the plural recording media based on a result of the reading process executed by the data reading unit; and a transportation control unit that causes the transportation unit to convey the recording media to different media storage units according to said attributes based on the identification results of the media identification unit.

In another aspect of the invention the media identification unit identifies the recording media to which data has not been written from among the plural recording media based on the result of the reading process.

In yet another aspect of the invention the data reading unit reads data indicating the type of the recording medium in the reading process, and the media identification unit identifies the type of each of the recording media based on the results of the reading process.

A media processing device according to these aspects of the invention can thus identify particular attributes of the recording media, such as the recording medium type, and can sort by attribute a plurality of intermingled recording media including recording media that may or may not have been previously used and recording media of uncertain type.

In a media processing device according to another aspect of the invention the media identification unit preferably identifies the recording medium as a non-rewritable disc on the condition that the data reading unit read non-rewritable data indicating that writing to the recording medium is not possible.

This aspect of the invention enables segregating recording media on which some unused recording area remains but which is set to read-only, that is, non-rewritable, from unused blank recording media and recording media that can still be written.

Yet further preferably in a media processing device according to another aspect of the invention the data reading unit reads all data written to the recording medium in the reading process, and the media identification unit identifies the recording medium as a damaged disc on the condition that at least part of said data is not read in the reading process.

This aspect of the invention enables separating recording media that have aged to the degree that at least some data recorded thereto is lost from the other usable recording media.

Yet further preferably, a media processing device according to another aspect of the invention also has a printing unit that prints identification information denoting the identification result of the recording medium on the label side of the recording medium.

This aspect of the invention enables the user to easily check the type of the selected recording media and whether or not writing to the recording medium is possible.

Yet further preferably, the printing unit prints the identification information in a specified identification information printing area on the label side.

This aspect of the invention enables printing the identification information so that it will not overlap images or other content printed on the label side. In addition, by printing the identification information in the same position on the label side of all identified recording media, the user can readily locate and confirm the identification information.

Another aspect of the invention is a media processing system that solves the foregoing and has a media processing device having a plurality of media storage units that are capable of storing a plurality of recording media, a data reading unit that executes a reading process to read data written to a plurality of the recording media, and a transportation unit that can convey the recording media to the plural media storage units and the data reading unit; and a host computer having a media identification unit that can identify individual attributes of the plural recording media based on a result of the reading process, and a transportation control unit that causes the transportation unit to convey the recording media to different media storage units according to said attributes based on the identification results.

The media processing system according to this aspect of the invention achieves the same effect as the media processing device described above. In addition, this aspect of the invention enables a single host computer to control a plurality of media processing devices while enabling each media processing device to identify particular attributes of the recording media, such as the recording medium type, and sort by attribute a plurality of intermingled recording media including recording media that may or may not have been previously used and recording media of uncertain type.

Yet another aspect of the invention is a media processing method of a media processing device that has a plurality of media storage units that are capable of storing a plurality of recording media, a data reading unit that executes a reading process to read data written to a plurality of the recording media, and a transportation unit that can convey the recording media to the plural media storage units and the data reading unit, the media processing method including: a media identification step of identifying individual attributes of the plural recording media based on a result of the reading process; and a transportation control step of causing the transportation unit to convey the recording media to different media storage units according to said attributes based on the identification results.

The media processing method according to this aspect of the invention achieves the same effect as the media processing device described above.

Yet another aspect of the invention is a program that causes a computer to function as a control device that controls a media processing device that can solve the foregoing problem, and more particularly causes the computer to function as a media identification unit that can identify individual attributes of the plural recording media based on a result of the reading process, and a transportation control unit that causes the transportation unit to convey the recording media to different media storage units according to said attributes based on the identification results.

A computer in which this program is installed can thus control a plurality of media processing devices while enabling each media processing device to identify particular attributes of the recording media, such as the recording medium type, and sort by attribute a plurality of intermingled recording media including recording media that may or may not have been previously used and recording media of uncertain type.

The foregoing summary of the invention does not describe all essential features of the invention, and the invention is also conceivable using subcombinations of these feature groups.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is block diagram showing the configuration of a media processing device 100 according to a preferred embodiment of the invention.

FIG. 2 is an oblique view showing the internal configuration of the media processing device 100.

FIG. 3 is a block diagram showing the configuration of the media drives 141 and 142.

FIG. 4 is a flow chart describing the recording medium identification process of the media processing device 100.

FIG. 5 is a block diagram showing the configuration of a media processing system 500 according to another embodiment of the invention.

FIG. 6 shows an example of the hardware configuration of a computer 1000.

### DESCRIPTION OF PREFERRED EMBODIMENTS

Preferred embodiments of the present invention are described below with reference to the accompanying figures. It should be noted that the embodiments described above do not limit the scope of the invention as described in the accompanying claims, and that all of the characteristic combinations of elements described in the accompanying embodiments are not essential to the invention.

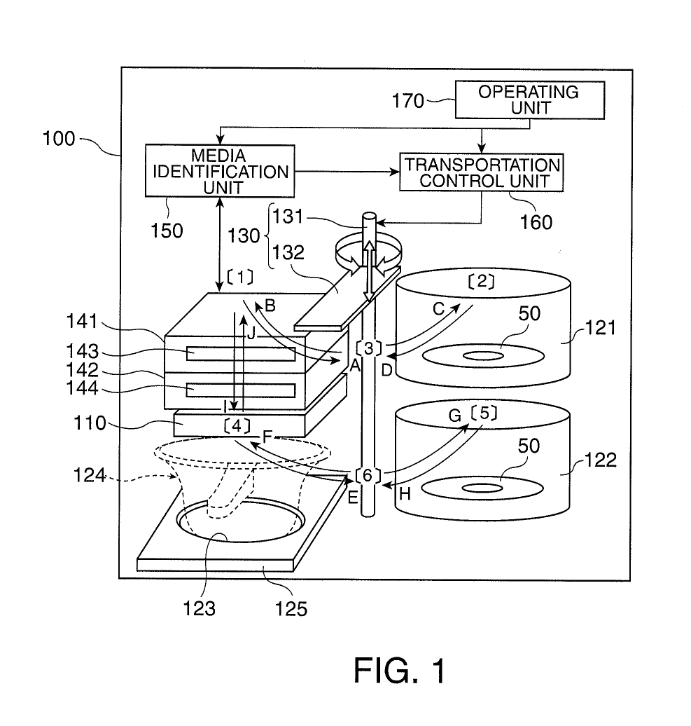

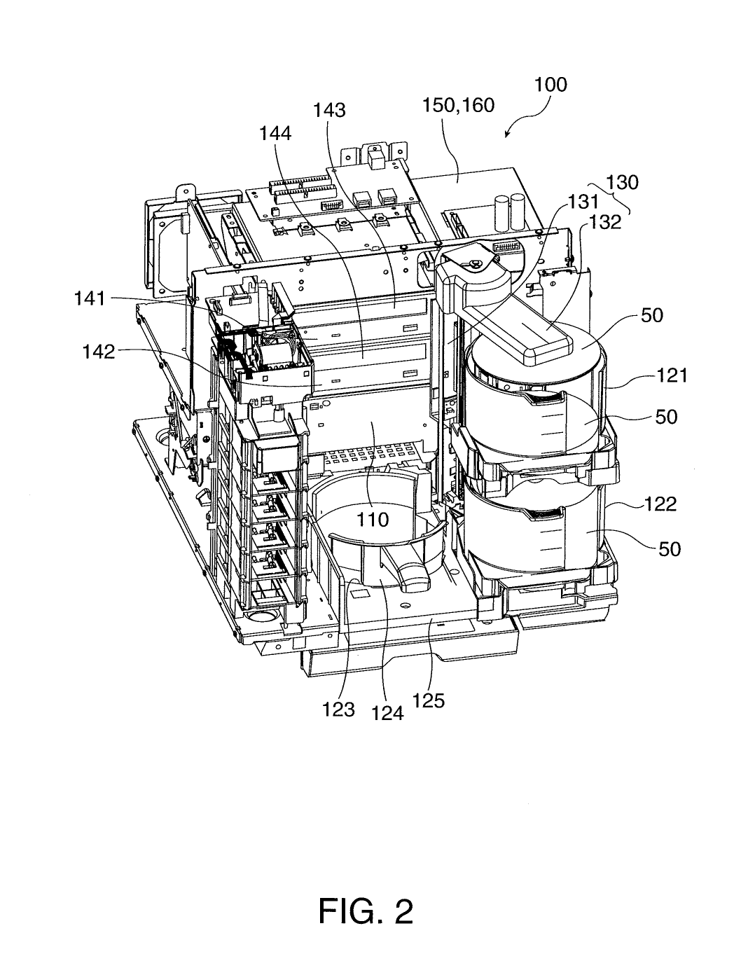

FIG. 1 is a block diagram showing the configuration of a media processing device 100 according to a preferred embodiment of the invention. FIG. 2 is an oblique view showing the internal configuration of the media processing device 100.

The media processing device 100 is a device for reading and writing data on disc-shaped media such as CDs and DVDs, and for printing on the label side of the recording media, and as shown in FIG. 1 and FIG. 2 has first to fourth media storage units 121, 122, 123, and 124, two media drives 141 and 142, a label printer 110, a transportation unit 130, a media identification unit 150, a transportation control unit 160, and an operating unit 170.

FIG. 2 shows the configuration of the devices inside the media processing device 100 with the rectangular box-like outside case removed, but the case is typically installed during use. An access door that opens and closes for loading and removing the recording media from the media processing device 100 is disposed at the front of the outside case, and an operating unit 170 having display indicators and operating buttons, for example, is disposed at the top of the case.

The first media storage unit 121 and the second media storage unit 122 disposed directly below the first media storage unit 121 are removably disposed to the frame of the media processing device 100, and each can store a plurality of recording media. A plurality of recording media 50 are stored in both the first media storage unit 121 and the second media storage unit 122 in the view shown in FIG. 2.

The third media storage unit 123 is a recess formed in the pull-out tray 125 that is disposed so that it can slide out to the front of the media processing device 100, and is used to store a small number of recording media.

The fourth media storage unit 124 is removably attached to the third media storage unit 123, and can hold a greater number of recording media than can the third media storage unit 123.

When writing data and printing a label on blank media using the media processing device 100, the first media storage unit 121 is used as a media supply stacker storing the blank media, and the second media storage unit 122 and fourth media storage unit 124 are used as discharge stackers that store the finished recording media after the data writing process and label printing are completed.

Alternatively, the first media storage unit 121 may be used as a discharge stacker, or the second media storage unit 122 and fourth media storage unit 124 may be used as media supply stackers. The third media storage unit 123 is provided as a substitute discharge stacker that is used when the fourth media storage unit 124 being used as a discharge stacker is removed.

By thus providing this third media storage unit 123, the data writing and label printing processes can continue uninterrupted when the fourth media storage unit 124 is removed to recover the recording media thereinside when the data writing and label printing processes are being applied to the blank recording media and the fourth media storage unit 124 becomes full and can store no additional media.

As further described below, when the recording media identification process executes using the media processing device 100, the first media storage unit 121, for example, stores a plurality of intermixed recording media including possibly blank recording media and recording media of unknown type, and is used as the media supply stacker. In this situation the second media storage unit 122 and fourth media storage unit 124 are used as discharge stackers for storing recording media identified by type or other attribute according to the particular attribute.

Each of the two media drives 141 and 142 has a drive tray 143, 144, respectively, that slides open and closed. Each of the media drives 141 and 142 also has a data reading unit for reading data written on the recording medium loaded on the drive tray 143, 144, and a data writing unit for writing data on the recording media.

The label printer 110 is an example of a printing unit of the invention, and is an inkjet recording device capable of printing on the label side of recording media. This label printer 110 can print a preset label image and identification information as further described below on the label side of the recording medium conveyed to a specific media transfer position.

The transportation unit 130 has a vertical guide shaft 131 that is disposed substantially vertically, and a transportation arm 132 that can travel up and down along and can pivot on the vertical guide shaft 131. Fingers for gripping the recording medium are disposed in the center of the distal end of the transportation arm 132.

The transportation arm 132 can pivot as indicated by the arrows labelled A to H in FIG. 1, and can move vertically as indicated by the arrows labelled I and J. By combining these vertical travel and horizontal pivoting operations, the transportation arm 132 can move to the positions [1] to [6] in FIG. 1.

As a result, the transportation arm 132 can move between each of the first to fourth media storage units 121, 122, 123, 124 (that is, either the third media storage unit 123 or the fourth media storage unit 124) and the media transfer position of the media tray 143 disposed to the media drive 141, the media transfer position of the media tray 144 disposed to the media drive 142, and the media transfer position of the label printer 110.

The positions identified by reference numerals [1] to [6] in FIG. 1 are described next.

Position [1] is the home position (HP) (standby position) of the transportation arm 132; position [2] is the position of the first media storage unit 121; position [3] is a suitable position between the home position and the position of the first media storage unit 121; position [4] is the media transfer position of the label printer 110; position [5] is the position of the second media storage unit 122; and position [6] is a suitable position between the media transfer position of the label printer 110 and the position of the second media storage unit 122.

The transportation control unit 160 controls driving the transportation unit 130. The transportation control unit 160 outputs drive control information to the transportation unit 130 based on information related to various settings input by the user through the operating unit 170, and identification information from the media identification unit 150.

Based on this drive control information, the transportation unit 130 conveys recording media from the first media storage unit 121, for example, to the media transfer position of the second media storage unit 122, fourth media storage unit 124, or label printer 110, and the media transfer positions of the drive trays 143, 144 of the media drives 141 and 142.

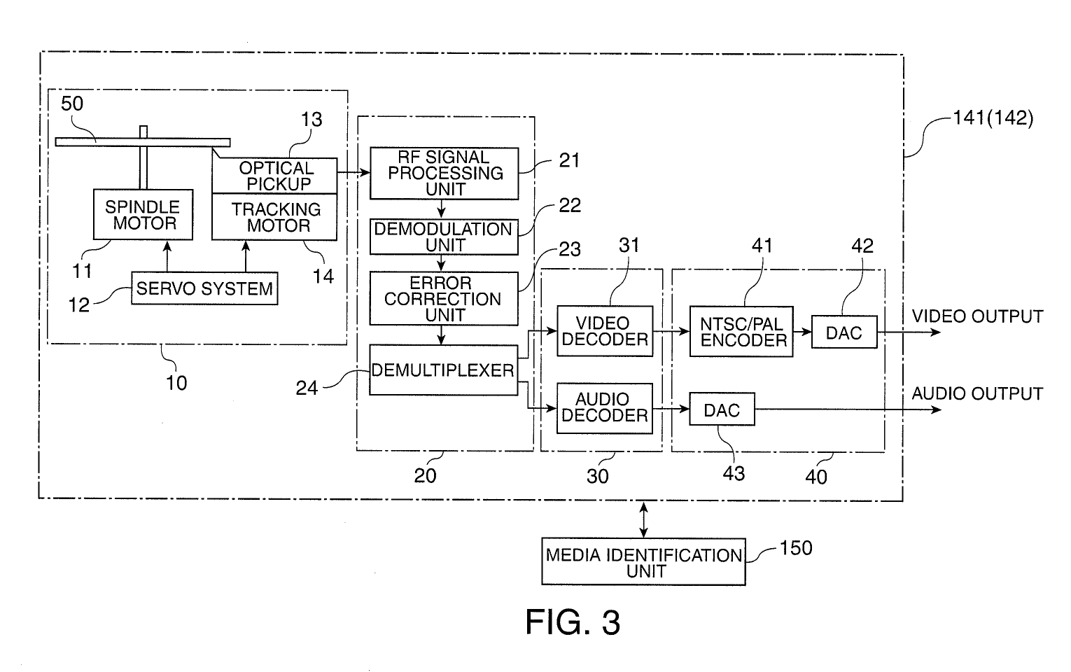

FIG. 3 is a block diagram showing the configuration of the media drive 141 (142). Each media drive 141 (142) has a disc drive 10 for reading data from the CD, DVD, or other disc-shaped recording media, a digital signal processing unit 20 that converts RF signals acquired by the disc drive 10 to digital data, a decoding unit 30 that expands and restores compressed data, and an output unit 40.

The disc drive 10 includes a spindle motor 11, an optical pickup 13, a tracking motor 14, and a servo system 12. The spindle motor 11 causes the DVD or other recording medium 50 to rotate, operates the optical pickup 13 by means of the tracking motor 14, and reads data recorded on the disc-shaped recording medium by means of the optical pickup 13. More specifically, the optical pickup 13 emits a specific laser beam to the recording medium 50 and receives the light reflected from the recording medium 50. The CD and DVD compatible pickup technology used in this embodiment of the invention includes, for example, dual pickup configurations, twin objective lens configurations, and dual focal point lens configurations.

The spindle motor 11 and tracking motor 14 are controlled by the servo system 12.

The digital signal processing unit 20 includes an RF signal processing unit 21, a demodulation unit 22, an error correction unit 23, and a demultiplexer 24.

The RF signal processing unit 21 converts the signal waveform (RF signal) of the reflection beam picked up by the optical pickup 13 to digital data.

The demodulation unit 22 demodulates the digital data, which is encoded according to a specific modulation scheme (such as 8/16 modulation) before being recorded, to the original data format.

The error correction unit 23 applies error correction to the demodulated data using a specified error correction method (such as RS-PC (Reed-Solomon Product Code)).

The demultiplexer 24 demultiplexes the digital data output from the error correction unit 23 into the constituent streams of video data, caption data, and audio data, for example.

The decoding unit 30 includes a video decoder 31 and an audio decoder 32.

The video decoder 31 expands and restores to the original form video data that was previously compressed according to a specified format (such as MPEG-2).

The audio decoder 32 similarly expands and restores to the original form audio data that was previously compressed according to a specified format (such as AC-3).

The output unit 40 includes an NTSC/PAL encoder 41, and D/A converters 42 and 43.

The NTSC/PAL encoder 41 encodes the video signal (color difference signal) reproduced by the video decoder 31 to the appropriate NTSC or PAL format, for example, for viewing on a television receiver.

D/A converter 42 converts the encoded digital data output by the NTSC/PAL encoder 41 to an analog signal, and outputs the analog signal.

D/A converter 43 converts the audio signal (such as a linear PCM signal) reproduced by the audio decoder 32 to an analog signal, and outputs the analog signal.

The media identification unit 150 includes a storage unit for storing information required to identify the type of recording medium 50 or the recording format of the data recorded on the recording medium, and a software program that can reproduce data recorded in a plurality of recording formats. The media identification unit 150 includes a CPU that controls various function blocks, executes specific calculations, and controls operation of the media processing device 100, RAM that is used as working memory by the CPU, and ROM that stores control programs executed by the CPU, for example.

The media identification unit 150 identifies the type of recording medium 50 based on the physical format recorded to the lead-in area of the recording medium 50 loaded in the disc drive 10, for example. The media identification unit 150 also identifies the file format of the recorded data based on information (such as identifier tags) related to the file system of the recording medium 50, and identifies the corresponding software program from the file structure recorded on the recording medium 50. Based on the identified file format and software program, the media identification unit 150 also selects and executes the software application that can reproduce the data recorded on the recording medium 50 from among the plural software applications recorded in the storage unit.

Table 1 shows an example of the recording media types and recording formats (application formats and file formats) that can be identified in the media processing device 100.

TABLE 1

| | | | |
|---|---|---|---|
| Application | CD-DA | PC data, CD-Video | DVD-Video, DVD-Audio, |
| format | | | DVD-VR |
| File format | CD-DA | Juliet, ISO-9660, | UDF Bridge (ISO-9660 + |
| | | UDF | UDF 1.02), UDF 2.0 |

| | | |
|---|---|---|
| Physical | CD-ROM, CD-R/RW | DVD-ROM, DVD-R/RW, |
| format | | DVD+R/RW, DVD-RAM |

More specifically, the media processing device 100 determines the type of the recording medium (CD-DA (audio CD), CD-ROM, CD-R/RW, DVD-ROM, DVD-R/RW, DVD+R/RW, DVD-RAM) loaded in the media drive by means of the media identification unit 150 applying the process described above to the recording medium loaded in the media drive 141 (142). In addition, by reading data from the recording medium of an identified type, the media processing device 100 determines, for example, whether the recording medium is a blank disc or is a rewritable disc.

Based on the user's settings, the media processing device 100 can also read all data written to each recording medium of identified type, for example. If part of the data cannot be read from the recording medium that is read in the reading process, that is, if a read error occurs, the media processing device 100 can also segregate the recording medium as a damaged disc from the normal recording media.

It should be noted that the media processing device 100 in this embodiment of the invention is compatible with such application formats as CD Audio, PC data, CD Video, DVD-Video, DVD-Audio, and DVD-VR, and with such file formats as ISO-9660, UDF Bridge (ISO-9660+ UDF 1.02), and UDF 2.0.

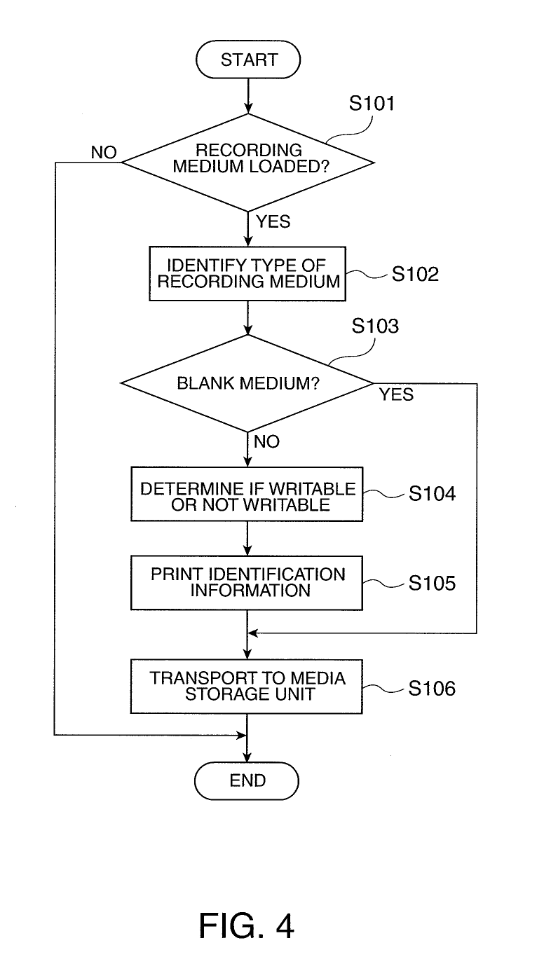

FIG. 4 is a flow chart showing an example of a recording media identification process executed by the media processing device 100. The media processing device 100 according to this embodiment of the invention applies the recording media identification process described according to this flow chart to each of the plural recording media stored in the media supply stacker (first media storage unit 121 in this embodiment).

As shown in FIG. 4, the media drives 141 and 142 first detect if a recording medium is loaded on the respective drive tray 143, 144 (step S101). If a loaded recording medium is detected on either drive tray 143, 144 (step S101 returns Yes), the corresponding media drive 141 and 142 sends a signal indicating the drive tray on which a recording medium is loaded to the media identification unit 150. If a recording medium is not loaded on either drive tray 143, 144 (step S101 returns No), this process ends. Alternatively, the media drives 141 and 142 may again detect if a recording medium is loaded on the respective drive tray 143, 144 at a predetermined time interval or when a signal requesting recording medium detection is received from the media identification unit 150.

The media identification unit 150 then identifies the type of recording medium that is loaded (step S102). More specifically, whether or not the loaded recording medium is a CD-DA disc is determined by the media drives 141 and 142 detecting a physical characteristic (such as the reflectance) of the recording medium loaded in the drive tray 143, 144, or detecting the physical format recorded in the lead-in area. For example, a method using the S-curve focus error signal produced when the objective lens of the optical pickup 13 moves away from the recording medium may be used to detect whether or not the recording medium is a CD-DA medium. The media drive 141 and 142 then sends a signal indicating whether the recording medium is a CD-DA disc or other type of medium to the media identification unit 150.

When the type of the loaded recording medium is determined to be a CD-DA disc, the media identification unit 150 selects and executes a CD-DA application program, or more particularly selects a program for CD-Audio media. If the type of the loaded recording medium is determined to be other than CD-DA, the media drive 141, 142 executes a reading process to read the data written to the recording medium. More specifically, the data reading unit of the media drive 141, 142 reads the file management information recorded on the recording medium, and sends the file management information that was read to the media identification unit 150.

The media identification unit 150 then interprets the file management information received from the data reading unit of the media drive 141, 142, and determines if the recording medium is a blank medium (step S103). If the recording medium is a blank medium (step S103 returns Yes), the media identification unit 150 sends information identifying the recording medium as a blank medium to the transportation control unit 160. Based on this information from the media identification unit 150, the transportation control unit 160 then outputs drive control information instructing the transportation unit 130 to convey the recording medium to the media storage unit that stores blank media (that is, the blank media storage unit).

The transportation unit 130 then transports the recording medium from the media drive 141, 142 to the blank media storage unit based on this drive control information from the transportation control unit 160 (step S106). In this embodiment of the invention either one of media storage units 122 and 124 may be preselected as the blank media storage unit, or the blank media storage unit may be appropriately selected by the transportation control unit 160.

If in step S103 the recording medium is determined to not be a blank medium based on the interpreted file management information (step S103 returns No), the media identification unit 150 identifies the file format of the data recorded on the medium based on unique information (such as an identifier tag) related to the file system contained in the file management information of the recording medium. Because the file management information (or the structure thereof) differs according to the file system, the file format can be identified by using information unique to the file system.

The media identification unit 150 then interprets the file structure recorded to the recording medium. The media identification unit 150 also identifies the application format of the recorded data based on the interpreted file structure (application format identification means). For example, if there is a folder labelled VIDEO_TS and a group of files is stored in that folder, the application format is identified as DVD-Video. If there is a group of files stored in a folder labelled AUDIO_TS, the application format is identified as DVD-Audio.

The media identification unit 150 then selects and executes the software application that can read data in the recording format combining the identified file format and application format. For example, if the file format is UDF 2.0 and the application format is identified as DVD-VR, the media identification unit 150 executes the software application that can reproduce this recording format (the conventional DVD-VR mode). As a result, the data reading unit of the media drive 141, 142 reads the data recorded to the recording medium.

The media identification unit 150 then determines if the recording medium is a rewritable disc (step S104). More specifically, if the data reading unit of the media drive 141, 142 reads non-rewritable data indicating that writing to the recording medium is not possible, the media identification unit 150 identifies the recording medium as a non-rewritable disc. If this non-rewritable data is not read, the media identification unit 150 determines that the recording medium is a rewritable disc.

If the recording medium is a rewritable disc, specific data may be written by the data writing unit of the media drive 141, 142. This specific data may be, for example, data that was preset by the user of the media processing device 100 for writing to a rewritable disc.

If in this step any part of said data is not read by the time the data reading unit of the media drive 141, 142 reads all of the data written on the recording medium, the media identification unit 150 identifies the recording medium as a defective disc. As a result, recording media that have aged to a degree that data dropout errors occur when reading the recorded data can be separated from the other recording media.

The media identification unit 150 then sends information (recording media identification information) indicating the result of determining the recording medium type and whether or not the medium is a rewritable disc to the label printer 110. The media identification unit 150 also sends information indicating that recording media identification has ended to the transportation control unit 160.

Based on this information from the media identification unit 150, the transportation control unit 160 then outputs drive control information for conveying the recording medium to the label printer 110 to the transportation unit 130.

Based on this drive control information from the transportation control unit 160, the transportation unit 130 then transports the recording medium from the media drive 141, 142 to the label printer 110.

The label printer 110 prints identification information describing the recording medium identification result on the label side of the recording medium conveyed from the media drive 141, 142 (step S105). If in this step the label printer 110 receives with this identification information from the media identification unit 150 information indicating the area where the identification information is to be printed (the identification information printing area) on the label side of the recording medium, the identification information is printed in this identification information printing area. Note that this identification information printing area is preferably positioned where it will not interfere with images printed on the label side, such as near the inside circumference or outside circumference on the label side of the disc.

Because identification information showing the recording medium identification result is printed on the label side of the recording medium, the user can easily read the identification information, such as the media type and whether the disc is rewritable or not, for each of the sorted recording media. Furthermore, by printing the identification information in an identification information printing area, the identification information can be printed so that it will not overlap images or other content printed on the label side of the recording medium. Yet further, by printing the identification information in the same position (identification information printing area) on the label side of all identified recording media, the user can readily check the identification information.

When the identification information is printed on the label side of the recording medium in step S105, the label printer 110 sends information indicating that printing ended to the media identification unit 150.

The media identification unit 150 then sends information indicating that recording medium identification and identification information printing are completed to the transportation control unit 160.

Based on this information from the media identification unit 150, the transportation control unit 160 outputs drive control information instructing the transportation unit 130 to convey the recording medium to the media storage unit based on the identification result.

Based on this drive control information from the transportation control unit 160, the transportation unit 130 then transports the recording medium to the media storage unit based on the identification result (step S106). This completes the recording media identification process according to this flow chart.

Note that in this embodiment of the invention the media storage unit selected based on the identification result may be the media storage unit 122, 124 that was not selected as the blank media storage unit. If plural recording media identification results are received, the media processing device 100 may be equipped with a blank media storage unit and additional media storage units equal to the number of possible identification results.

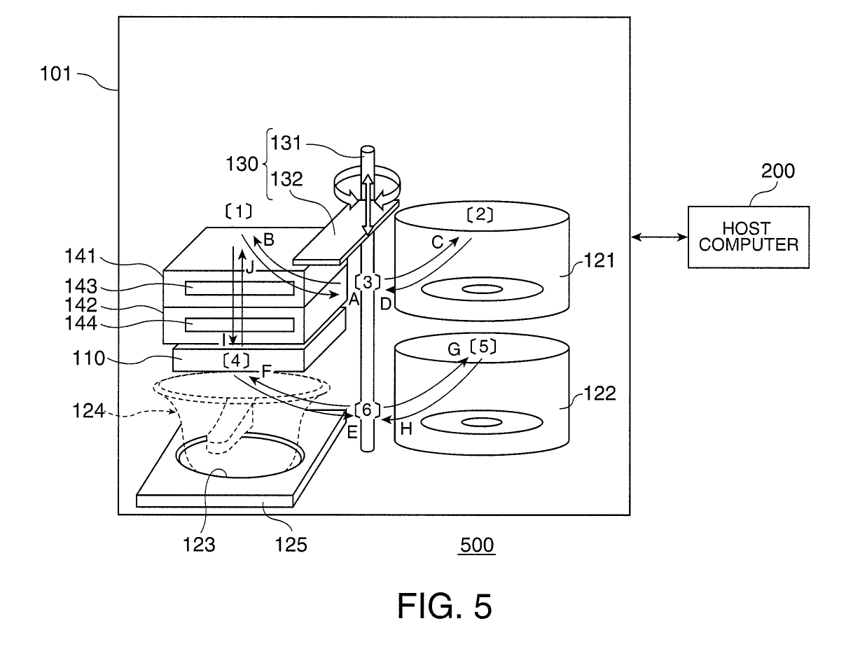

FIG. 5 is a block diagram showing the configuration of a media processing system 500 according to another embodiment of the invention.

This media processing system 500 has a media processing device 101 and a host computer 200.

The processing device 101 has all of the components of the foregoing media processing device 100 except for the media identification unit 150 and transportation control unit 160. These components of the processing device 101 have the same function as the similar components of the media processing device 100 described above, are therefore identified by the same reference numerals, and further description thereof is omitted.

The host computer 200 has the functions of the media identification unit 150 and transportation control unit 160 in the media processing device 100 described above. Therefore, when the processing device 101 executes the recording media identification process, the host computer 200 functions as a control device of the processing device 101.

It should be noted that the media processing system 500 in this embodiment of the invention is composed of a host computer 200 and one processing device 101, but the media processing system 500 may be configured with a host computer 200 and a plurality of processing devices 101. By thus rendering the functions of the media identification unit and transportation control unit in the host computer 200, the configuration of the media processing device can be simplified, and the recording media identification process can be run more efficiently as a result of a single host computer controlling a plurality of media processing devices.

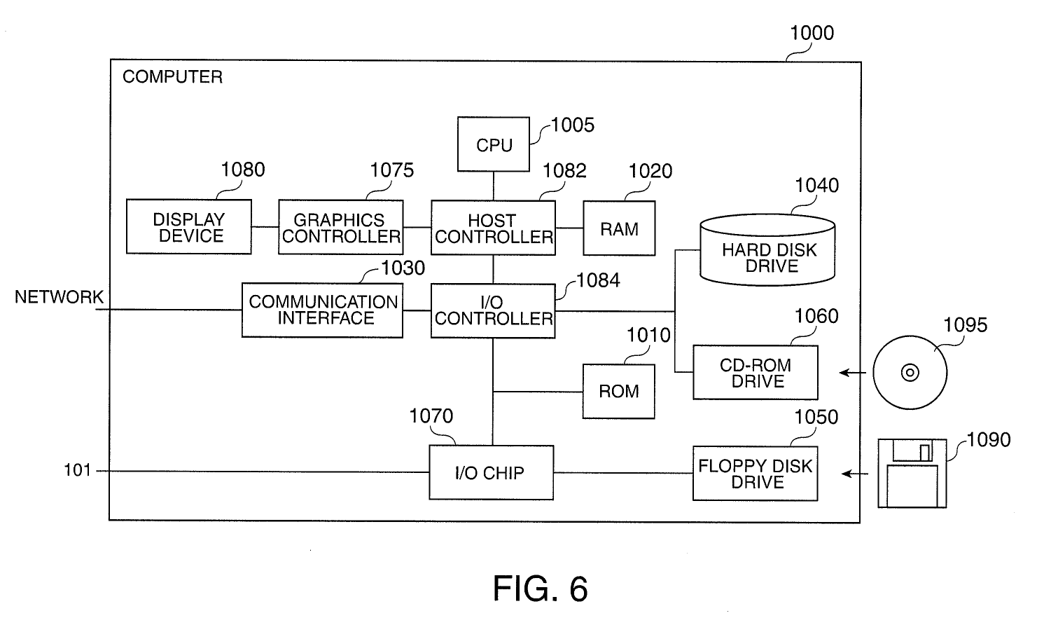

FIG. 6 shows the hardware configuration of the computer 1000. The computer 1000 functions as the host computer 200 of the media processing system 500 described in FIG. 5 based on a supplied program. For example, when the computer 1000 functions as the host computer 200, the program causes the computer 1000 to function as the component elements of the host computer 200 described in FIG. 5.

The computer 1000 has a CPU unit, an input/output unit, and a legacy input/output unit.

The CPU unit includes a CPU 1005 connected with a host controller 1082, RAM 1020, a graphics controller 1075, and a display device 1080.

The input/output unit includes a communication interface 1030 connected to the host controller 1082 through an I/O controller 1084, a hard disk drive 1040, and a CD-ROM drive 1060.

The legacy input/output unit includes ROM 1010 connected to the I/O controller 1084, a floppy disk drive 1050, and an I/O chip 1070.

The host controller 1082 connects the RAM 1020 to the graphics controller 1075 and CPU 1005 that accesses the RAM 1020 at a high data transfer rate. The CPU 1005 operates according to programs and data stored in ROM 1010 and RAM 1020, and controls other parts.

The graphics controller 1075 acquires image data created by the CPU 1005 in a frame buffer rendered in RAM 1020, and displays the image on the display device 1080. The frame buffer for storing image data created by the CPU 1005 may alternatively be rendered internally to the graphics controller 1075.

The I/O controller 1084 connects the host controller 1082 to the communication interface 1030, which is a relatively high speed input/output device, a hard disk drive 1040, and a CD-ROM drive 1060. The communication interface 1030 communicates with other devices over a network. The hard disk drive 1040 stores programs and data used by the CPU 1005 in the computer 1000. The CD-ROM drive 1060 reads and passes programs and data from a CD-ROM disc 1095 through RAM 1020 to the hard disk drive 1040.

ROM 1010, a floppy disk drive 1050, and the relatively low speed input/output device of the I/O chip 1070 are connected to the I/O controller 1084.

ROM 1010 stores the boot program that is executed when the computer 1000 starts up, and programs that depend on the hardware of the computer 1000.

The floppy disk drive 1050 reads and provides programs and data from a floppy disk 1090 through the RAM 1020 to the hard disk drive 1040.

The I/O chip 1070 connects the floppy disk drive 1050 and various types of other input/output devices through, for example, a parallel port, serial port, a keyboard port, and a mouse port.

The program supplied through RAM 1020 to the hard disk drive 1040 is provided by the user stored on a floppy disk 1090, CD-ROM disc 1095, IC card, or other type of recording medium. The program is read from the recording medium, installed through RAM 1020 to the hard disk drive 1040 of the computer 1000, and executed by the CPU 1005.

The program is installed on the computer 1000. The program works through the CPU 1005 and causes the computer 1000 to function as the foregoing media identification unit and transportation control unit.

This program may further be stored on an external recording medium. Examples of such recording media include in addition to floppy disks 1090 and CD-ROM discs 1095, DVDs, CDs, and other types of optical recording media, MO discs and other types of magneto-optical recording medium, magnetic tape media, and IC cards and other types of semiconductor memory. Further alternatively, a storage device such as a hard disk drive or RAM included in a server system connected to a dedicated communication network or the Internet may be used as the recording medium, and the program may be provided through the network to the computer 1000.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A media processing device comprising:
a plurality of media storage units that are capable of storing a plurality of recording media;
a data reading unit that executes a reading process to read data written to a plurality of the recording media;
a transportation unit that can convey the recording media to the plural media storage units and the data reading unit;
a media identification unit that can identify individual attributes of the plural recording media based on a result of the reading process executed by the data reading unit; and
a transportation control unit that causes the transportation unit to convey the recording media to different media storage units according to said attributes based on the identification results of the media identification unit.

2. The media processing device described in claim 1, wherein:
the media identification unit identifies the recording media to which data has not been written from among the plural recording media based on the result of the reading process.

3. The media processing device described in claim 1, wherein:
the data reading unit reads data indicating the type of the recording medium in the reading process; and
the media identification unit identifies the type of each of the recording media based on the results of the reading process.

4. The media processing device described in claim 1, wherein:
the media identification unit identifies the recording medium as a non-rewritable disc on the condition that the data reading unit read non-rewritable data indicating that writing to the recording medium is not possible.

5. The media processing device described in claim 1, wherein:
the data reading unit reads all data written to the recording medium in the reading process; and
the media identification unit identifies the recording medium as a damaged disc on the condition that at least part of said data is not read in the reading process.

6. The media processing device described in claim 1, further comprising:
a printing unit that prints identification information denoting the identification result of the recording medium on the label side of the recording medium.

7. The media processing device described in claim 6, wherein:
the printing unit prints the identification information in a specified identification information printing area on the label side.

8. A media processing system comprising:
a media processing device having a plurality of media storage units that are capable of storing a plurality of recording media, a data reading unit that executes a reading process to read data written to a plurality of the recording media, and a transportation unit that can convey the recording media to the plural media storage units and the data reading unit; and
a host computer having a media identification unit that can identify individual attributes of the plural recording media based on a result of the reading process, and a transportation control unit that causes the transportation unit to convey the recording media to different media storage units according to said attributes based on the identification results.

9. The media processing system described in claim 8, wherein:
the media identification unit identifies the recording media to which data has not been written from among the plural recording media based on the result of the reading process

10. The media processing system described in claim 8, wherein:
the data reading unit reads data indicating the type of the recording medium in the reading process; and
the media identification unit identifies the type of each of the recording media based on the results of the reading process.

11. The media processing system described in claim 8, wherein:
the media identification unit identifies the recording medium as a non-rewritable disc on the condition that the data reading unit read non-rewritable data indicating that writing to the recording medium is not possible.

12. The media processing system described in claim 8, wherein:
the data reading unit reads all data written to the recording medium in the reading process; and
the media identification unit identifies the recording medium as a damaged disc on the condition that at least part of said data is not read in the reading process.

13. A media processing method of a media processing device that has a plurality of media storage units that are capable of storing a plurality of recording media,
a data reading unit that executes a reading process to read data written to a plurality of the recording media, and
a transportation unit that can convey the recording media to the plural media storage units and the data reading unit,
the media processing method comprising:
a media identification step of identifying individual attributes of the plural recording media based on a result of the reading process; and
a transportation control step of causing the transportation unit to convey the recording media to different media storage units according to said attributes based on the identification results.

14. The media processing method described in claim 13, wherein:
the media identification step identifies the recording media to which data has not been written from among the plural recording media based on the result of the reading process.

15. The media processing method described in claim 13, wherein:
the data reading unit reads data indicating the type of the recording medium in the reading process; and
the media identification step identifies the type of each of the recording media based on the results of the reading process.

16. The media processing method described in claim 13, wherein:
the media identification step identifies the recording medium as a non-rewritable disc on the condition that the data reading unit read non-rewritable data indicating that writing to the recording medium is not possible.

17. The media processing method described in claim 13, wherein:
the data reading unit reads all data written to the recording medium in the reading process; and
the media identification step identifies the recording medium as a damaged disc on the condition that at least part of said data is not read in the reading process.

18. The media processing method described in claim 13, further comprising:
a printing step of printing identification information denoting the identification result of the recording medium on the label side of the recording medium.

19. The media processing method described in claim 18, wherein:
the printing step prints the identification information in a specified identification information printing area on the label side.
